(19) United States
(12) Patent Application Publication
(10) Pub. No.: US 2006/0129666 A1
(43) Pub. Date: Jun. 15, 2006

(54) Selective device reset method for device sharing with fail-over

(75) Inventors: David E. Bohm, Tucson, AZ (US); Erick C. Kissel, Tucson, AZ (US); Jeou-Rong Lay, San Jose, CA (US)

Correspondence Address: CARDINAL LAW GROUP, 1603 ORRINGTON AVENUE, SUITE 2000, EVANSTON, IL, 60201, US

(73) Assignee: International Business Machines Corporation, Armonk, NY (US)

(21) Appl. No.: 11/008,399

(22) Filed: Dec. 9, 2004

(51) Int. Cl. G06F 15/173

(52) U.S. Cl. 709/223

(57) ABSTRACT

A device manager manages assignments of a plurality of devices by two or more device clients. To this end, the device manager detects an operational failure with a device client running an application based at least partially on an assignment of one or more devices among the plurality of devices. Next, the device manager exclusively resets each assigned device reserved by the device client in response to the detection of the operational failure with the device client while preserving any reservation among the remaining devices.

### FIELD OF INVENTION

The present invention generally relates to fail-over methods for a high availability environment. The present invention specifically relates to a method for resetting a device assigned to an application server in response to a fail-over state of that application server.

### BACKGROUND OF THE INVENTION

In a high availability environment, a fail-over measure is implemented for a fail-over application server to take over operations of a primary application server when the primary application server is experiencing an operational problem. Examples of such an operational problem includes an inability to communicate on the associated network, a system crash, an application crash, and hardware errors that prevent the primary application server from being able to successfully complete operations. When the failover occurs, the fail-over application server launches the applications that were running on the primary application server and takes over the hardware and TCP/IP addresses of the primary application server. When the application is restarted on the fail-over application server, the application is not aware of the fact that it is now running on the fail-over application server. In fact, it would only appear to the application that it was stopped and then restarted.

One drawback to the implementation of a fail-over measure when the primary application server is experiencing an operational problem can be an inability of the application as restarted by the fail-over application server to use any reserved device previously being used by the application when the operational problem occurred on the primary application server. A challenge therefore for the computer industry is to develop techniques for implementing a fail-over measure when needed while facilitating a use by an application as restarted on the fail-over application server of all devices previously reserved by the application when the operational problem occurred on the primary application server without impacting the performance of any device.

### SUMMARY OF THE INVENTION

The present invention provides a new and unique method of managing an assignment of a device to an application server.

One form of the present invention is a signal bearing medium tangibly embodying a program of machine-readable instructions executable by one or more processor(s) to manage assignments of a plurality of devices among a plurality of device clients. The operations include (1) detecting an operational failure of a device client running an application based at least partially on an assignment to the device client of at least one device among the plurality of devices; and (2) exclusively resetting each device among the at least one device assigned to the device client and reserved by the device client in response to the detection of the operational failure of the device client while preserving any assignment and reservation among the remaining devices by the other device clients.

A second form of the present invention is system employing one or more processors, and one or more memories for storing instructions operable with the processor(s) for managing assignments of a plurality of devices among a plurality of device clients. The instructions include (1) detecting an operational failure of a device client running an application based at least partially on an assignment to the device client of at least one device among the plurality of devices; and (2) exclusively resetting each device among the at least one device assigned to the device client and reserved by the device client in response to the detection of the operational failure of the device client while preserving any assignment and reservation among the remaining devices by the other device clients.

A third form of the present invention is server for assignments of a plurality of devices among a plurality of device clients. The server includes (1) means for detecting an operational failure of a device client running an application based at least partially on an assignment to the device client of at least one device among the plurality of devices; and (2) means for exclusively resetting each device among the at least one device assigned to the device client and reserved by the device client in response to the detection of the operational failure of the device client while preserving any assignment and reservation among the remaining devices by the other device clients.

The forgoing forms and other forms, objects, and aspects as well as features and advantages of the present invention will become further apparent from the following detailed description of the various embodiments of the present invention, read in conjunction with the accompanying drawings. The detailed description and drawings are merely illustrative of the present invention, rather than limiting the scope of the present invention being defined by the appended claims and equivalents thereof.

### BRIEF DESCRIPTION OF THE DRAWINGS

FIG. 1 illustrates an exemplary operational environment for a device manager and a device client in accordance with the present invention;

FIG. 2 illustrates flowcharts representative of one embodiment of a device management method in accordance with the present invention;

FIG. 3 illustrates a flowchart representative of one embodiment of device assignment request management method in accordance with the present invention;

FIG. 4 illustrates an exemplary device management table in accordance with the present invention;

FIG. 5 illustrates flowcharts representative of one embodiment of a device client restart method in accordance with the present invention;

FIG. 6 illustrates an exemplary pre device client fail-over status and a post device client fail-over status of the device management table illustrated in FIG. 4;

FIG. 7 illustrates flowcharts representative of one embodiment of a device manager polling method in accordance with the present invention;

FIG. 8 illustrates flowcharts representative of one embodiment of a device manager restart method in accordance with the present invention; and

FIG. 9 illustrates an exemplary pre device manager restart status and a post device manager restart status of the device management table illustrated in FIG. 4.

### DESCRIPTION OF THE PREFERRED EMBODIMENT

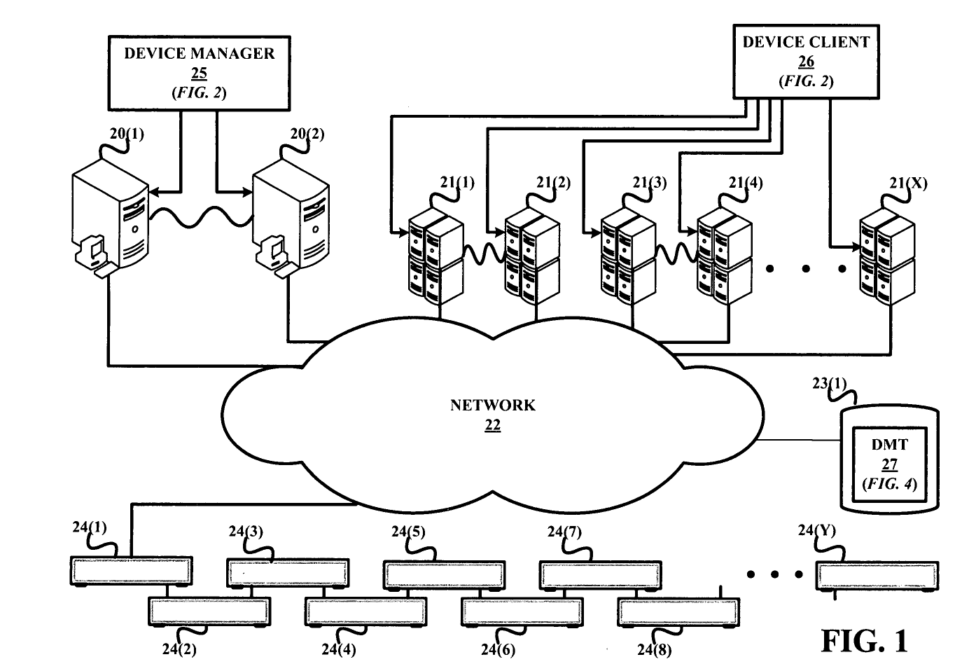

Device managers and device clients of the present invention are computer modules structurally configured with hardware, software and/or firmware to implement various conventional applications for a particular computer environment, and to implement a new and unique selective reset of devices within that computer environment in response to any restart of a device manager and in response to any detected operational failure of a device client by a device manager. In practice, the manner by which device managers and device clients of the present invention are structurally configured for practicing the present invention is without limit. Therefore, the description of the following embodiments of a device manager 25 and a device client 26 as incorporated within an exemplary computer environment as illustrated in FIG. 1 is not a limitation as to the scope of a device manager and a device client of the present invention.

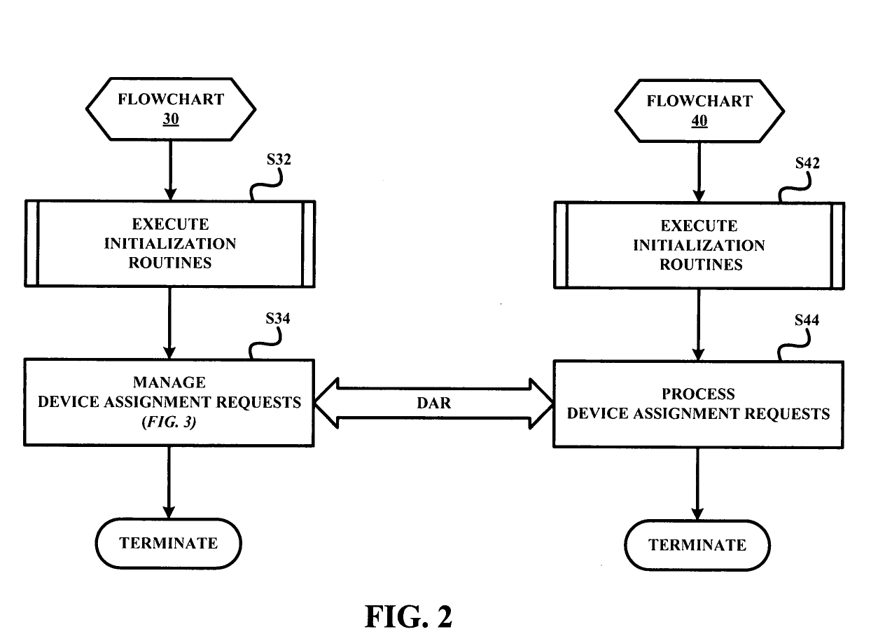

Referring to FIG. 1, a pair of conventional device management servers 20(1) and 20(2), a X number of application servers 21(1)-21(X), where X≧2, a database 23 and a Y number of devices 24(1)-24(Y), where Y≧2, are interconnected via a conventional network 22. Device manager 25 is installable on each device management server 20, and device client 26 is installable on each application server 21 to facilitate an implementation of a device management method of the present invention as represented by flowcharts 30 and 40 illustrated in FIG. 2.

Referring to FIGS. 1 and 2, a stage S32 of flowchart 30 encompasses an execution of initialization routines by each device manager 25 where these initialization routines include conventional initialization routines as would be appreciated by those having ordinary skill in the art, and a new and unique routine for designating one of the device management servers 21 for running its device manager 25 as a primary device manager and the other device management server 21 for initializing its device manager 25 in response to an operational failure of the primary device manager 25. Similarly, a stage S42 of flowchart 40 encompasses an execution of initialization routines by each device client 26 (FIG. 1) where these initialization routines include conventional initialization routines as would be appreciated by those having ordinary skill in the art for facilitating a running of an application based, partially or entirely, on assignments of devices 24 to application servers 21, and a new and unique task for registering which of the device managers 25 installed on device management servers 20 is the primary device manager.

To facilitate an understanding of the present invention, a stage S34 of flowchart 30 and a stage S44 of flowchart 40 will now be described herein as if the device managers 25 installed on device management servers 20 and the device clients 26 installed on application servers 21 concurrently executed stages S32 and S42, respectively, upon an initial operation of the computer environment illustrated in FIG. 1. Those having ordinary skill in the art will however appreciate the applicability of flowcharts 30 and 40 to additional device managers 25 and additional device clients 26 subsequently introduced into the computer environment shown in FIG. 1 and to restarts performed by the existing device managers 25 and existing device clients 26 shown in FIG. 1.

Stages S34 and S44 encompass a management by the primary device manager 25 of each conventional device assignment request DAR received from a device client 26. Generally, a device client 26 will communicate a device assignment request DAR to the primary device manager 25, which will either accept, deny or queue the device assignment request DAR in dependence as to whether one or more devices among devices 24 responsive to the device assignment request DAR are available. If the device assignment request DAR is accepted by the primary device manager 25 whereby one or more of the devices among devices 24 is assigned by primary device manager 25 to the requesting device client 26, then the requesting device client 26 can reserve the assigned device(s) 24 to thereby perform one or more tasks via the assigned device(s) 24. Upon completion of the task(s), the requesting device client 26 releases the reservation of the assigned device(s) 24 and notifies the primary device manager 25 of the reservation release whereby the primary device manager 25 can designate the assigned device(s) 24 as being available for assignment in the device management table 27.

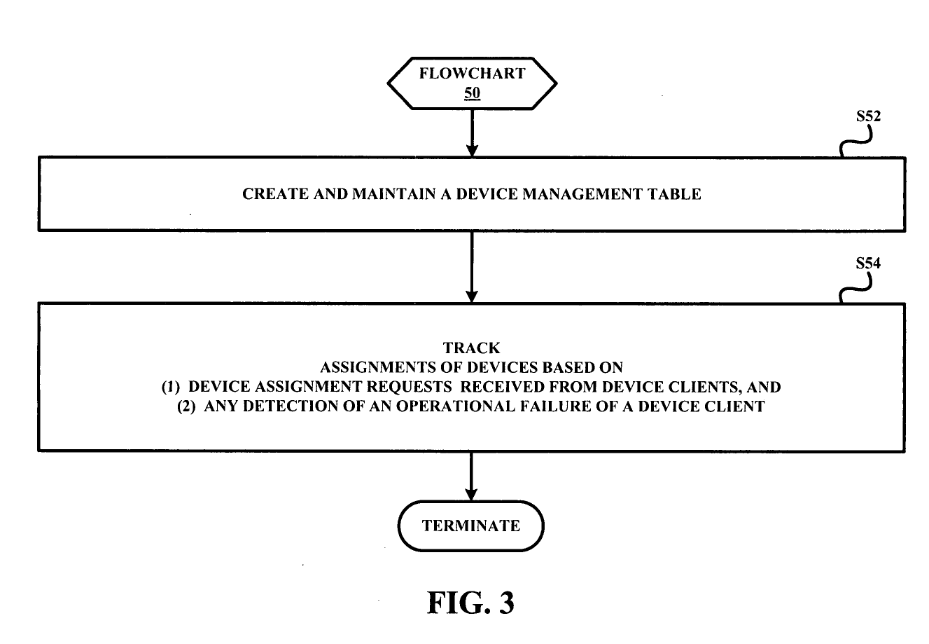

In one embodiment of stage S34, the primary device manager 25 implements a device assignment request management method of the present invention as represented by a flowchart 50 illustrated in FIG. 3. However, in practice, the actual manner by which the primary device manager 25 implements stage S34 is without limit. Thus, the following description of flowchart 50 is not a limitation as to the scope of stage S34.

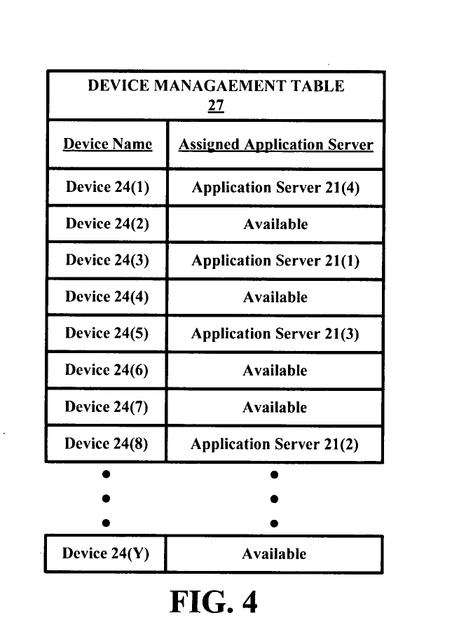

Referring to FIGS. 1 and 3, the primary device manager 25 creates a device management table (“DMT”) 27 within database 23 during a stage S52 of flowchart 50. In one exemplary embodiment, as illustrated in FIG. 4, device management table 27 includes a device column listing each device 24 by device name, and an assigned application server column listing which application server among application servers 21 has been assigned the corresponding device 24 in the table.

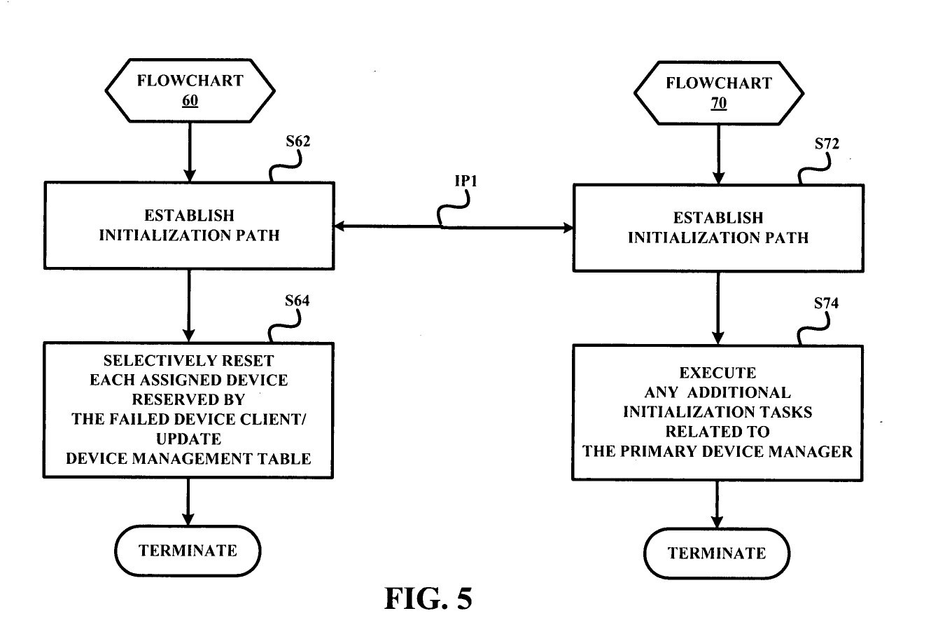

Thereafter, the primary device manager 25 will manage device management table 27 during a stage S54 of flowchart 50 based on (1) conventional device assignment requests DAR received from device clients 21, and (2) any detection by the primary device manager 25 of an operational failure by one of the device clients 21. In practice, the manner in which the primary device manager 25 detects an occurrence of an operational failure of one of the device clients 21 is without limit. Thus, the following description of FIGS. 5-7 is not a limitation as to the scope of stage S54.

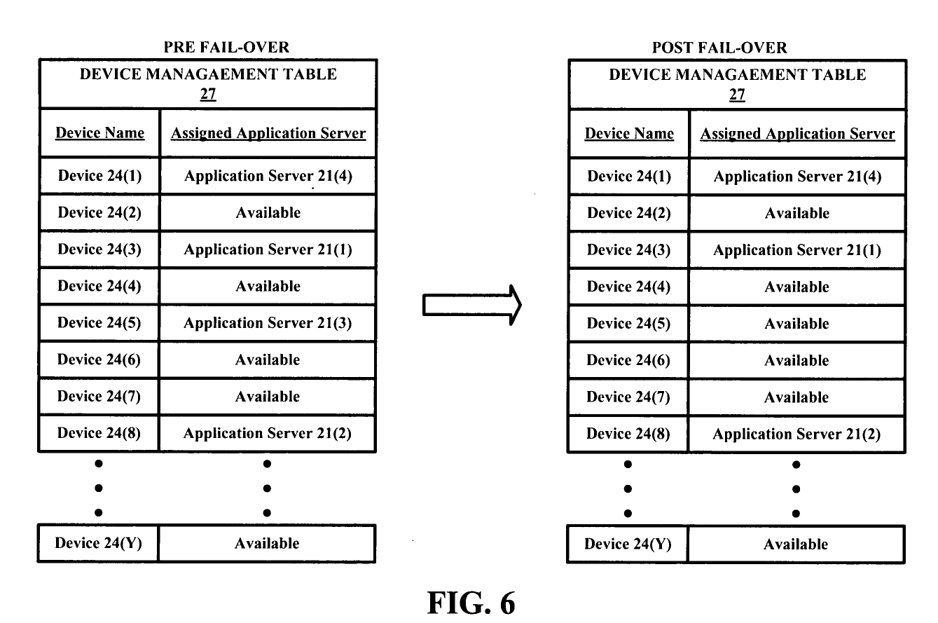

Referring to FIGS. 1 and 5, a flowchart 60 and a flowchart 70 are implemented by the primary device manager 25 and a failover device client 26, respectively, upon a restart of the failed device client 26 on a fail-over application server 21 by the failover device client 26 in accordance with flowchart 40 (FIG. 2). Specifically, the operational failure of the failed device client 26 triggers an establishment of an initialization path IP1 between the primary device manager 25 and the failover device client 26 during a stage S62 of flowchart 60 and a stage S72 of flowchart 70. The primary device manager 25 interprets initialization path IP1 as an indication of the operational failure of the failed device client 26 whereby, during a stage S64 of flowchart 60, the primary device manager 25 selectively resets each device 24 assigned to the failed device client 26 that was also reserved by the failed device client 26 prior to the restart by the failover device client 26 and updates device management table 27 to reflect that each reset device 24 is now available for assignment. For example, as illustrated in FIG. 6, if the failed device client 26 was running on application server 21(3) and device 24(5) was assigned to application server 21(3) prior to the restart, then the primary device manager 25 would conventionally release assigned device 24(5) from the reservation previously established by the failed device client 26.

In practice, the manner by which the primary device manager 25 resets each device 24 reserved by the failed device client 26 is without limit. In one embodiment, the primary device manager 25 queries an AIX ODM database for a logical unit number (“LUN”) of each device 24 reserved by the failed device client 26 prior to the restart whereby the primary device manager utilizes the LUN to reset the device(s) 24.

A stage S74 of flowchart 70 encompasses the failed device client 26 to execute any additional initialization tasks related to the primary device manager 25.

Those having ordinary skill in the art will appreciate that, upon the termination of flowcharts 60 and 70, the released device 24 will now be available for assignment to one of the device client 26 as will be reflected in device management table 27, and any reservation among the remaining assigned devices 24 was preserved.

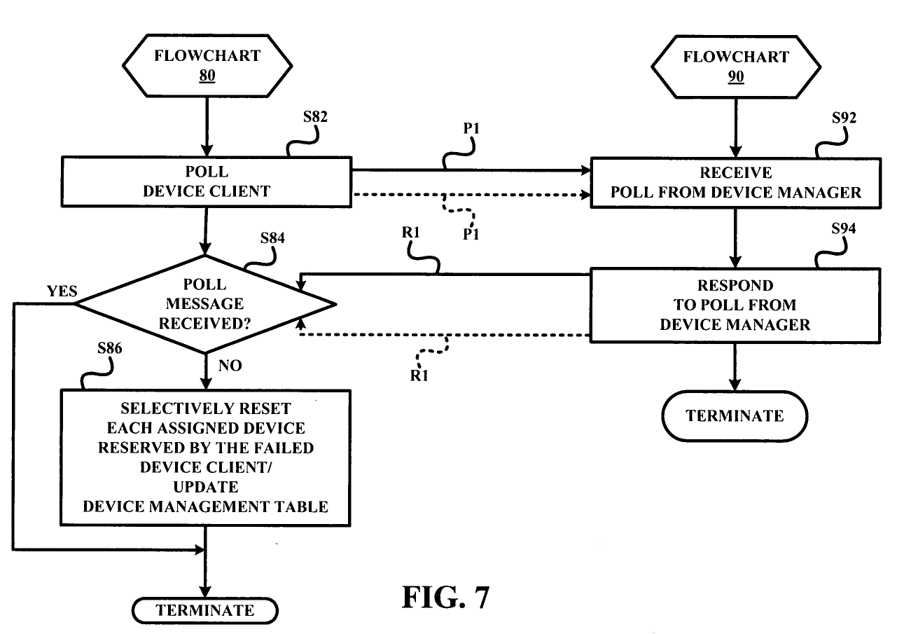

Referring to FIGS. 1 and 7, a flowchart 80 and a flowchart 90 can be implemented in accordance with a schedule by the primary device manager 25 and each device client 26, respectively, during stage S54 (FIG. 3) to enable the primary device manager 25 to actively ascertain operational failures by the device clients 26. Specifically, during a stage S82 of flowchart 80, the primary device manager 25 will poll a device client 26 via a poll message P1 that may or may not be received by the device client 26. If poll message P1 is received by the device client 26 during a stage S92 of flowchart 90 as indicated by the solid arrow, then the device client 26 will proceed to a stage S94 of flowchart 90 to respond to the poll message P1 via a reply message R1. If reply message R1 is timely received by the primary device manager 25 during a stage S84 of flowchart 80 as indicated by the solid arrow, then the primary device manager 25 will terminate flowchart 80. Otherwise, if reply message R1 is not timely received by the primary device manager 25 during stage S84 as indicated by the dashed arrow, then the primary device manager 25 interprets the failure to timely receive the reply message R1 as an operational failure of the device client 26 whereby the primary device manager 25 selectively reset each device 24 assigned to the failed device client 26 that was reserved by the failed device client 26 during a stage S86 of flowchart 80.

Those having ordinary skill in the art will appreciate that, upon the termination of flowcharts 80 and 90, the released device 24 will now be available for assignment to each active device client 26, and all reservations among the remaining assigned devices 24 were preserved.

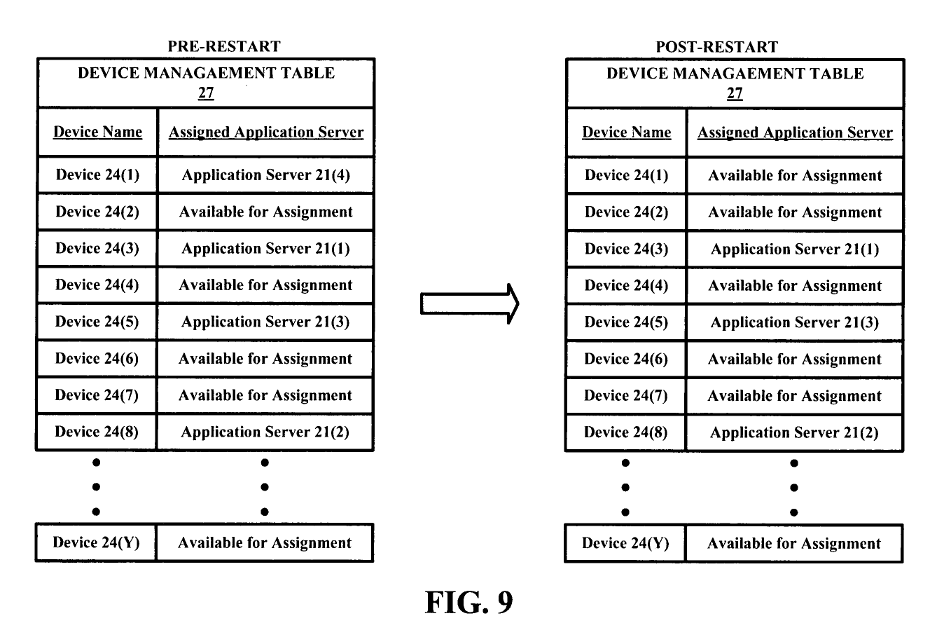

Referring to FIGS. 1 and 3, from the description herein of FIGS. 5-7, those having ordinary skill in the art will appreciate the numerous advantages of flowchart 50. In particular, the selective reset by the primary device manager 25 of reserved devices 24 under detected operational states of device clients 26. Those having ordinary skill in the art will further appreciate the fact that the primary device manager 25 may fail, and therefore be restarted on a new device management server 20 by its device manager 25. FIG. 9 illustrates flowcharts 120 and 130 as representations of a device manager restart method of the present invention.

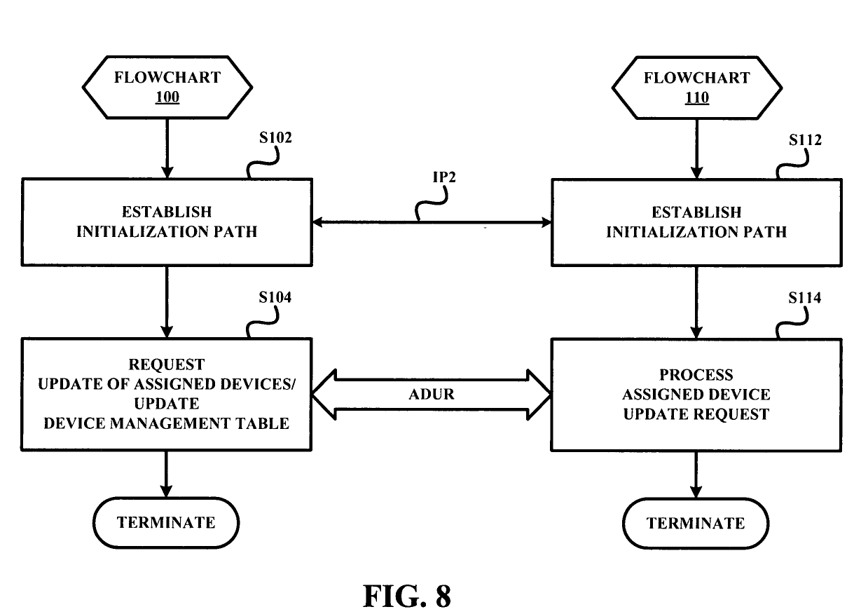

Referring to FIGS. 1 and 8, flowcharts 100 and 110 are implemented by the failover device manager 25 and each device client 26, respectively, upon a restart by the failover device manager 25 on a new device management server 20 in accordance with flowchart 30 (FIG. 2). Specifically, the failover device manager 25 triggers an establishment of an initialization path IP2 between the failover device manager 25 and a device client 26 during a stage S102 of flowchart 100 and a stage S112 of flowchart 110. The failover device manager 25 thereafter proceeds to a stage S104 of flowchart 100 to request an update of all devices 24 assigned to each device client 26 via an assignment device update request message ADUR. The device client 26 will process the message ADUR during a stage S114 of flowchart 110 whereby the failover device manager 25 will update the device management table 27 by selectively resetting each assigned device 24 reserved by the device client 26 and designating these device(s) 24 as being available for assignment if the device client 26 fails to timely response to the message ADUR, or by designating an assigned device 24 to a device client 26 as being available for assignment if the device client 26 indicates the assigned device 24 has been released by the device client 26. For example, as illustrated in FIG. 9, if the device client 26 running on application server 21(4) did not timely response to the message ADUR, then the failover device manager 25 would conventionally release device 21(4) if it was reserved by the device client and update device management table 27 to reflect device 21(4) is available for assignment. Or, if the device client 26 indicates that device 24(1) has been released by device client 26, then the failover device manager 25 would just update device management table 27 to reflect device 21(4) is available for assignment.

Those having ordinary skill in the art will appreciate that, upon the termination of flowcharts 100 and 110, the released device 24 will now be available for assignment to any of the device clients 26, and all reservations among the remaining devices 24 were preserved.

Referring again to FIG. 1, in a practical embodiment, device manager 25 and device client 26 are embodied as a software module written in a conventional language integrated with a commercially available software application entitled “IBM Tivoli Storage Manager”. As such, device manager 25 and device client 26 are installed within a memory of a server or distributed among various server memories whereby the server processor(s) can execute device manager 25 and device client 26 to perform various operations of the present invention as described in connection with the illustrations of FIGS. 2-9.

While the embodiments of the present invention disclosed herein are presently considered to be preferred embodiments, various changes and modifications can be made without departing from the spirit and scope of the present invention. The scope of the invention is indicated in the appended claims, and all changes that come within the meaning and range of equivalents are intended to be embraced therein.

We claim:

1. A signal bearing medium tangibly embodying a program of machine-readable instructions executable by at lease one processor to perform operations to manage assignments of a plurality of devices among a plurality of device clients, the operations comprising:
detecting an operational failure of a first device client running an application based at least partially on an assignment to the first device client of at least one device among the plurality of devices; and
exclusively resetting each device among the at least one device assigned to the first device client and reserved by the first device client in response to the detection of the operational failure of the first device client while preserving any assignment and reservation among the remaining devices by the other device clients.

2. The signal bearing medium of claim 1, wherein the operations further comprise:
creating and maintaining a device management table listing each device among the plurality of devices, and each assignment of one of the devices to one of the device clients.

3. The signal bearing medium of claim 2, wherein the operations further comprise:
updating a device management table to reflect the exclusive resetting of each device among the at least one device assigned to the first device client and reserved by the first device client.

4. The signal bearing medium of claim 1, detecting the operational failure of the first device client includes:
receiving a request to establish an initialization path with a second device client that is restarting the application.

5. The signal bearing medium of claim 1, detecting the operational failure of the first device client includes:
polling the first device client; and
failing to timely receive a reply from the first device client in response to the polling of the first device client.

6. A system, comprising:
at least one processor; and
at lease one memory storing instructions operable with the at lease one processor for managing assignments of a plurality of devices among a plurality of device clients, the instructions being executed for:
detecting an operational failure of a first device client running an application based at least partially on an assignment to the first device client of at least one device among the plurality of devices; and
exclusively resetting each device among the at least one device assigned to the first device client and reserved by the first device client in response to the detection of the operational failure of the first device client while preserving any assignment and reservation among the remaining devices by the other device clients.

7. The system of claim 6, wherein the instructions are further executed for:
creating and maintaining a device management table listing each device among the plurality of devices, and each assignment of one of the devices to one of the device clients.

8. The system of claim 7, wherein the instructions are further executed for:
updating the device management table to reflect the exclusive resetting of each device among the at least one device assigned to the first device client and reserved by the first device client.

9. The system of claim 6, wherein detecting the operational failure of the first device client includes:
receiving a request to establish an initialization path with a second device client that is restarting the application.

10. The system of claim 6, wherein detecting the operational failure of the first device client includes:
polling the first device client; and
failing to timely receive a reply from the first device client in response to the polling of the first device client.

11. A server for managing assignments of a plurality of devices among a plurality of device clients, comprising:
means for detecting an operational failure of a first device client running an application based at least partially on an assignment to the first device client of at least one device among the plurality of devices; and
means for exclusively resetting each device among the at least one device assigned to the first device client and reserved by the first device client in response to the detection of the operational failure of the first device client while preserving any assignment and reservation among the remaining devices by the other device clients.

12. The server of claim 11, further comprising:
means for creating and maintaining a device management table listing each device among the plurality of devices, and each assignment of one of the devices to one of the device clients.

13. The server of claim 12, further comprising:
means for updating the device management table to reflect the exclusive resetting of each device among the at least one device assigned to the first device client and reserved by the first device client.

14. A signal bearing medium tangibly embodying a program of machine-readable instructions executable by at lease one processor to perform operations by a first device manager for restarting a management of assignments of a plurality of devices among a plurality of device clients, the operations comprising:
requesting an update of each device assigned to a first device client in response to an operational failure of a second device manager managing each device assigned to the first device client; and
exclusively resetting a first device assigned to the first device client in response to an indication from the first device client that the first device client has released the first device.

15. A system, comprising:
at least one processor; and
at lease one memory storing instructions operable with the at lease one processor for restarting a management of assignments of a plurality of devices among a plurality of device clients, the instructions being executed by a first device manager for:
requesting an update of each device assigned to a first device client in response to an operational failure of a second device manager managing each device assigned to the first device client; and
exclusively resetting a first device assigned to the first device client in response to an indication from the first device client that the first device client has released the first device.

16. A server for operating a first device manager to manage assignments of a plurality of devices among a plurality of device clients, the server comprising:
means for requesting an update of each device assigned to a first device client in response to an operational failure of a second device manager managing each device assigned to the first device client; and
means for exclusively resetting a first device assigned to the first device client in response to an indication from the first device client that the first device client has released the first device.

17. A signal bearing medium tangibly embodying a program of machine-readable instructions executable by at lease one processor to perform operations by a first device manager for restarting a management of assignments of a plurality of devices among a plurality of device clients, the operations comprising:
requesting an update of each device assigned to a first device client in response to an operational failure of a second device manager managing each device assigned to the first device client; and
exclusively resetting a first device assigned to the first device client in response to a failure of the first device client to reply to a message indicative of an update of the assignment of the first device to the first device client.

18. A system, comprising:
at least one processor; and
at lease one memory storing instructions operable with the at lease one processor for restarting a management of assignments of a plurality of devices among a plurality of device clients, the instructions being executed by a first device manager for:
requesting an update of each device assigned to a first device client in response to an operational failure of a second device manager managing each device assigned to the first device client; and
exclusively resetting a first device assigned to the first device client in response to a failure of the first device client to reply to a message indicative of an update of the assignment of the first device to the first device client.

19. A server for operating a first device manager to manage assignments of a plurality of devices among a plurality of device clients, the server comprising:
means for requesting an update of each device assigned to a first device client in response to an operational failure of a second device manager managing each device assigned to the first device client; and
means for exclusively resetting a first device assigned to the first device client in response to a failure of the first device client to reply to a message indicative of an update of the assignment of the first device to the first device client.
